(19) United States
(12) Patent Application Publication
(10) Pub. No.: US 2012/0100244 A1
(43) Pub. Date: Apr. 26, 2012

(54) PLASTIC INJECTION MOLD

(75) Inventors: JIAN-MING LI, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/910,668

(22) Filed: Oct. 22, 2010

(51) Int. Cl. B29C 45/40

(52) U.S. Cl. 425/556

(57) ABSTRACT

A plastic injection mold includes a stationary mold member, a movable mold member, an unloading mechanism, and a movable platen operating mechanism. The movable platen operating mechanism includes an elastic element and a stopping connection element. The elastic part element has an end coupled to an ejector plate and an opposite end positioned against the movable platen by extending through a receiving hole defined in an auxiliary platen. The movable platen is coupled to the auxiliary platen by the stopping element in a relatively movable manner. With the movable platen operating mechanism disposed on the movable mold member, ejection of a molded product from the mold can be carried out in a two-stage process, assuring successful and intact release of the product from the mold without causing undesired deformation.

### TECHNICAL FIELD OF THE INVENTION

The present invention relates to a mold, and especially to a plastic injection mold.

### BACKGROUND OF THE INVENTION

In the conventional plastic injection molding field, under the circumstances when forming a plastic product with a more complex shape, adhesion force on some parts of the molded product is very strong when the product is ejected. Thus, when the corresponding ejecting force of the product from the product ejection mechanism is unequal, it is easy to cause deformation on the parts of the product due to the strong ejecting force.

Referring to FIG. 5, an injection-molded product 80 having a complicated shape comprises a base 81, two parallel elastic arms 82 extending from a proximal wall of the base 81, and a lateral bulge 83 formed by protruding from a side of a proximal end of each of the elastic arms 82.

To eject the above-mentioned complicatedly-shaped injection-molded product 80, a common method is to utilize an inclined slide side action mechanism to achieve the purpose of product ejection. The method, however, requires occupying a large amount of space, and it is also easy to increase the production costs.

### SUMMARY OF THE INVENTION

An objective of the present invention is to provide a plastic injection mold for facilitating mold releasing of an injection-molded product without causing undesired deformation.

To achieve the foregoing objective, the present invention provides a plastic injection mold for forming an injection-molded product. The product comprises a base, an elastic arm extending from the base, and a lateral bulge protruding from one side of the elastic arm. The injection mold comprises a stationary mold member, a movable mold member mating with the stationary mold member, an unloading mechanism which is disposed on the movable mold member, and a movable platen operating mechanism which is disposed on the movable mold member. The movable mold member comprises a movable mold fixing plate, an auxiliary platen which is fixed on the movable mold fixing plate, and a movable platen which is movably disposed on the auxiliary platen. A molding rod is fixed on the auxiliary platen to define a molding cavity with the stationary mold member and the movable mold member. The molding cavity comprises an elastic arm molding portion which is located in the movable platen for forming the elastic arm and a protrusion molding portion for forming the lateral bulge. A receiving hole is defined in the auxiliary platen. The unloading mechanism comprises an ejector plate and a plurality of ejector pins fixed on the ejector plate. The ejector plate and the ejector pins are movable between the movable mold fixing plate and the auxiliary platen. The movable platen operating mechanism comprises an elastic element and a stopping element. The elastic element has an end coupled to the ejector plate and an opposite end extending through the receiving hole of the auxiliary platen to be positioned against the movable platen. The movable platen is coupled to the auxiliary platen by the stopping element in a relatively movable manner.

The present invention provides a movable platen operating mechanism disposed on the movable mold member, whereby the plastic injection mold of the present invention is operated in a two-stage process in ejecting a molded product from the plastic injection mold. This arrangement ensures the product to be successfully released from the mold without causing undesired deformation.

### BRIEF DESCRIPTION OF THE DRAWINGS

FIG. 1 is a cross-sectional view illustrating a plastic injection mold after closing according to the present invention;

FIG. 2 is a cross-sectional view illustrating a plastic injection mold in a first stage of the mold release according to the present invention;

FIG. 3 is a cross-sectional view illustrating a plastic injection mold in a second stage of the mold release according to the present invention;

FIG. 4 is a schematic view illustrating compression of lateral bulges of a molded product when forming the product in the stage of FIG. 3; and

FIG. 5 is a cross-sectional view illustrating a product intended to be formed by a conventional plastic injection mold and preferably formed by the plastic injection mold of the present invention.

### DETAILED DESCRIPTION OF THE PREFERRED EMBODIMENT

Reference will now be made in detail to a preferred embodiment of the invention, examples of which are illustrated in the accompanying drawings.

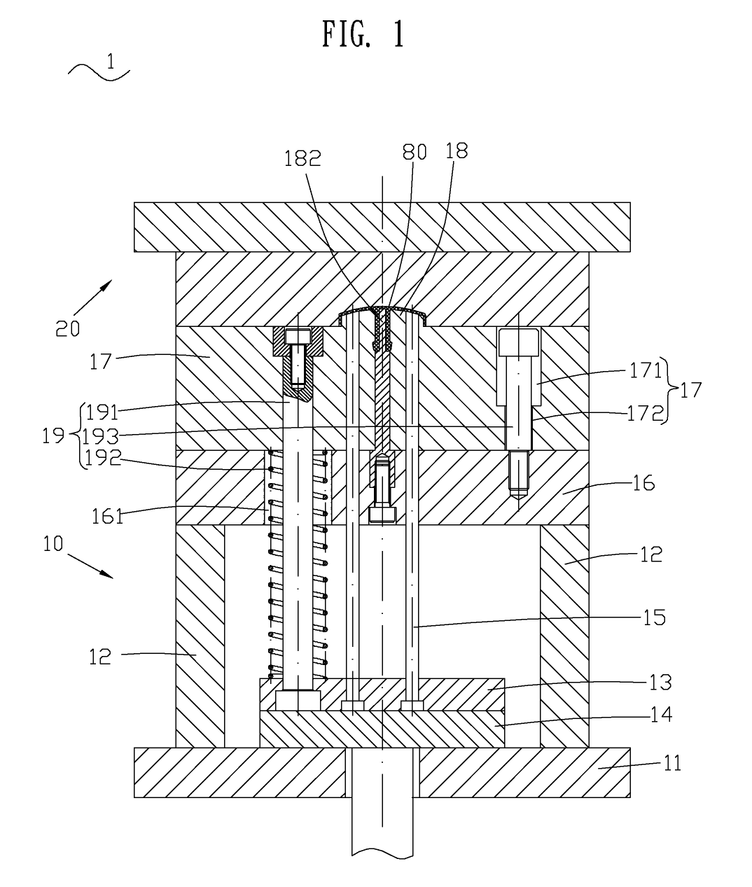

With reference to the drawings and in particular to FIG. 1, a plastic injection mold according to the present invention, generally designated as 1, includes a movable mold member 10 and a stationary mold member 20 mating the movable mold member 10.

The movable mold member 10 includes a movable mold fixing plate 11, two spacer plates 12, an ejector plate 13, an ejector retainer plate 14, a plurality of ejector pins 15, an auxiliary platen 16, a movable platen 17, a mold core 18 which is disposed in the movable platen 17, and a movable platen operating mechanism 19. The spacer plates 12 are fixed on the movable mold fixing plate 11, and the auxiliary platen 16 is fixed on the spacer plates 12. The movable platen 17 is movably disposed on the auxiliary platen 16. The ejector pins 15 are fixed on the ejector plate 13. The ejector plate 13 and the ejector retainer plate 14 are movable along the spacer plates 12 between the movable mold fixing plate 11 and the auxiliary platen 16. A receiving hole 161 is formed in the auxiliary platen 16.

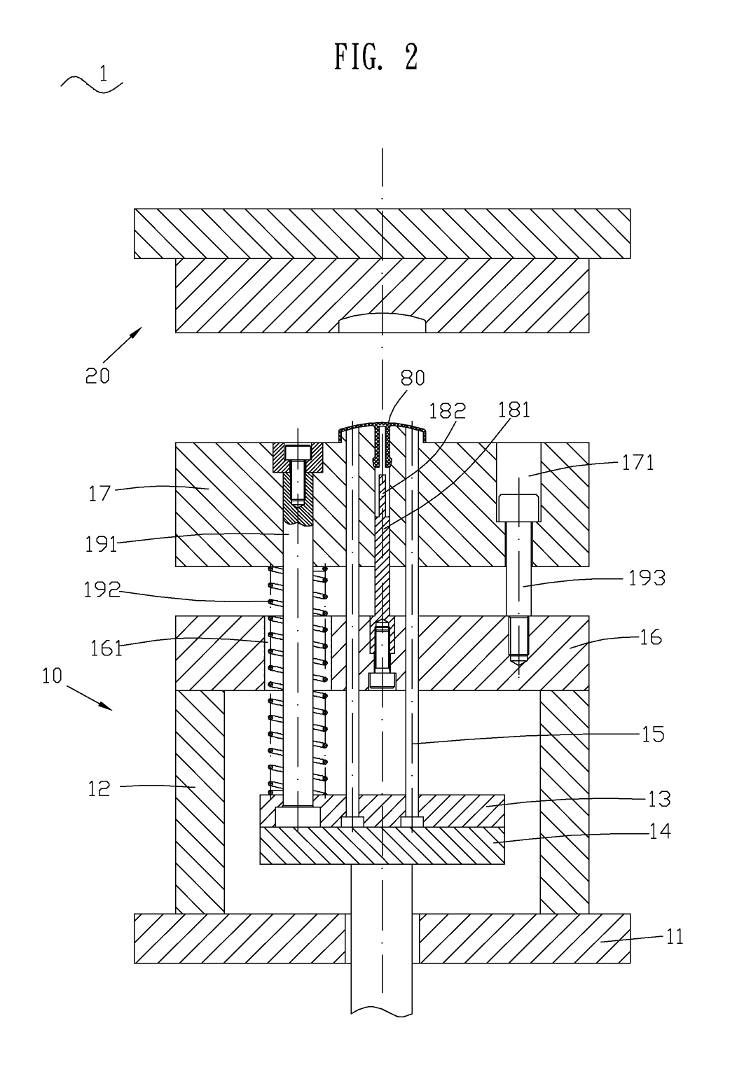

Referring to FIGS. 1 and 2, a stop hole 171 is defined in the movable platen 17. A bottom of the stop hole 171 is further recessed to define a connection hole 172 extending downward through the movable platen 17.

The mold core 18 has a base rod 181, and a molding rod 182 protrudes from an end of the base rod 181. The length of the molding rod 182 is less than the depth of the stop hole 171. The base rod 181 is fixed on the auxiliary platen 16, and a molding cavity 183 is defined by the molding rod 182 with the movable mold member 10 and the stationary mold member 20, wherein the molding cavity 183 is utilized to mold a product 80. The molding cavity 183 comprises an elastic arm molding portion 1831, which is located in the movable platen 17 for forming elastic arms 82 of the product 80 and a protrusion molding portion 1832 for forming lateral bulges 83. The molding rod 182 is utilized to assist in forming the elastic arms 82.

The movable platen operating mechanism 19 comprises a return rod 19, a spring 192, and a stopper bolt 193. One end of the return rod 19 is mounted on the ejector plate 13. The spring 192 is fitted over the return rod 181 and has opposite ends respectively positioned against the ejector plate 13 and the movable platen 17. The return rod 191 is inserted into the movable platen 17 through the receiving hole 161 of the auxiliary platen 16, and a part of the spring 192 is received in the receiving hole 161. The stopper bolt 193 is movably received in the stop hole 171, and extends through the connection hole 172 to fix to the auxiliary platen 16.

Referring to FIG. 2, in a first stage of mold releasing of the plastic injection mold 1, the movable mold member 10 is separated from the stationary mold member 20. The ejector retainer plate 14 and the ejector plate 13 are driven by the injection molding machine (not shown) to compress the spring 192 thereby moving the movable platen 17. Under this condition, the movable platen 17 is moving up in unison with the ejector retainer plate 14 and the ejector plate 13, and thus, the ejector pins 15 do not eject the product 80 out. Consequently, the product 80 is only gradually detaching from the molding rod 182 of the mold core 18. When an end of the stopper bolt 193 gets into contact the bottom of the stop hole 171, the movable platen 17 is no longer moved. Under this condition, the product 80 totally departs from the molding rod 182 of the mold core 18.

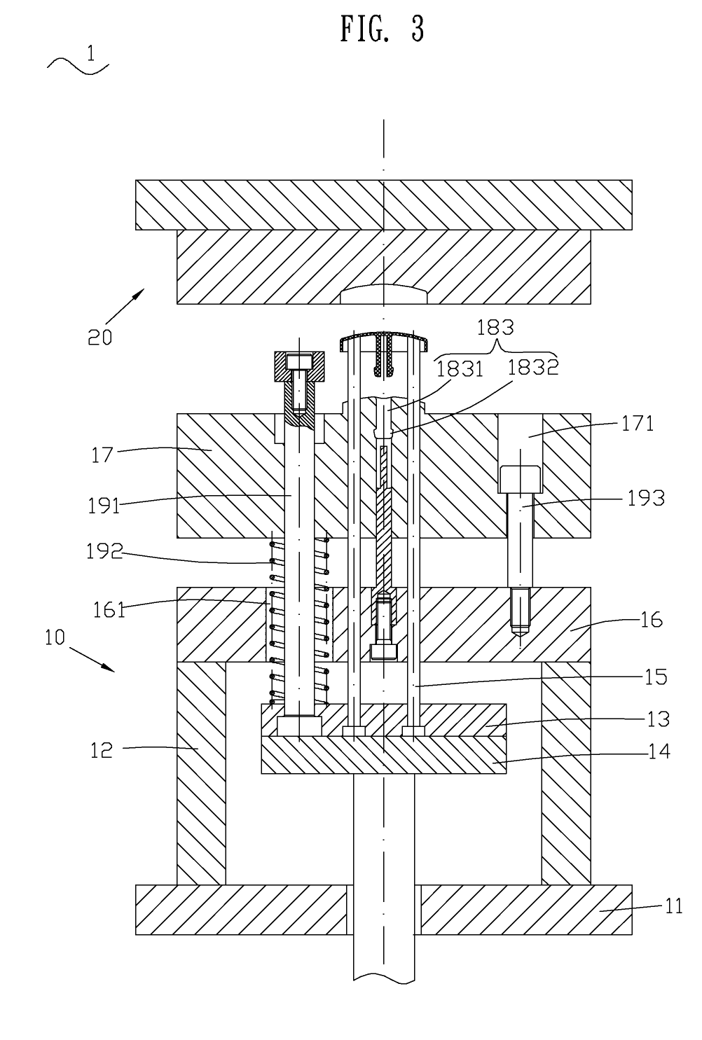

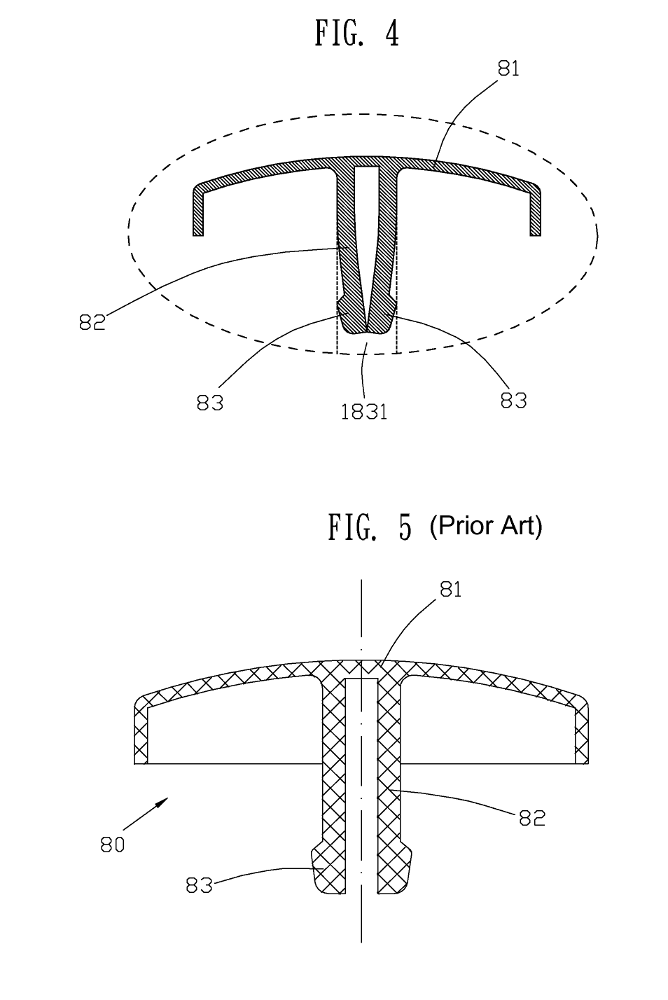

Referring to FIGS. 3 and 4, in a second stage of the mold releasing of the plastic injection mold 1, after the product 80 departs from the molding rod 182 of the mold core 18, the injection molding machine continues to push the ejector retainer plate 14 and ejector plate 13 for driving the ejector pins 15 to eject the product 80. In the ejection process, since the molding rod 182 has already been separated from the product 80, a gap is left between the elastic arms 82 of the product 80, thereby allowing the elastic arms 82 of the product 80 to move the lateral bulges 83 inward through elastic deflection toward the gap. This allows the lateral bulges 83 to be smoothly ejected from the molding cavity 183, making the product 80 separated from the movable mold member 10.

As mentioned above, the present invention provides a movable platen operating mechanism 19 disposed on the movable mold member 10, whereby the plastic injection mold 1 of the present invention is operated in a two-stage process in ejecting a product 80 from the plastic injection mold 1. This arrangement ensures the product 80 to be successfully released from the mold without causing undesired deformation.

While the preferred embodiment of the present invention has been illustrated and described in detail, various modifications and alterations can be made by persons skilled in this art. For instance, the stopper bolt can be replaced by chains or other connection parts. All these modifications and alterations should be covered in the appended claims.

What is claimed is:

1. An injection mold adapted to form an injection-molded product that has a base, an elastic arm extending from the base, and a lateral bulge protruding from one side of the elastic arm, the injection mold comprising:
a stationary mold member;
a movable mold member mating with the stationary mold member, the movable mold member comprising a movable mold fixing plate, an auxiliary platen fixed on the movable mold fixing plate, and a movable platen movably disposed on the auxiliary platen, a molding rod fixed on the auxiliary platen to define a molding cavity with the stationary mold member and the movable mold member, the molding cavity comprising an elastic arm molding portion located in the movable platen for forming the elastic arm and a protrusion molding portion for forming the lateral bulge, a receiving hole being defined in the auxiliary platen;
an unloading mechanism disposed on the movable mold member, the unloading mechanism comprising an ejector plate and a plurality of ejector pins fixed on the ejector plate, the ejector plate and the ejector pins being movable between the movable mold fixing plate and the auxiliary platen; and
a movable platen operating mechanism, disposed on the movable mold member, the movable platen operating mechanism comprising an elastic element and a stopping element, the elastic element having one end positioned on the ejector plate and an opposite end extending through the receiving hole of the auxiliary platen to be positioned against the movable platen, the stopping element coupling the movable platen to the auxiliary platen in a relatively movable manner.

2. The injection mold of claim 1, wherein the elastic element comprises a spring, which is fitted over a return rod, the return rod having an end mounted on the ejector plate, the return rod extending through the receiving hole of the auxiliary platen and inserted into the movable platen, a part of the spring being received in the receiving hole.

3. The injection mold of claim 1, wherein the stopping element comprises a stopper bolt, a stop hole being defined in the movable platen and receiving the stopper bolt therein, the stopper bolt being fixed on the auxiliary platen.
